(19) United States
(12) Patent Application Publication
(10) Pub. No.: US 2002/0005695 A1
(43) Pub. Date: Jan. 17, 2002

(54) Lamp unit and image projection apparatus

(76) Inventors: Tsuyoshi Ichibakase, Osaka (JP); Makoto Horiuchi, Nara (JP); Makoto Kai, Osaka (JP); Tomoyuki Seki, Osaka (JP); Mamoru Takeda, Kyoto (JP); Shinichi Yamamoto, Osaka (JP); Kenichi Sasaki, Osaka (JP)

Correspondence Address: HARNESS, DICKEY & PIERCE, PLC, P.O. BOX 828, BLOOMFIELD HILLS, MI, 48303, US

(21) Appl. No.: 09/881,159

(22) Filed: Jun. 14, 2001

(30) Foreign Application Priority Data
Jun. 16, 2000 (JP) 2000-181277

(51) Int. Cl. H01J 17/16

(52) U.S. Cl. 313/634

(57) ABSTRACT

A lamp unit includes a lamp provided with a mirror and a house for holding the lamp provided with a mirror. The lamp provided with a mirror includes a discharge lamp including a luminous bulb in which a luminous material is enclosed and a pair of electrodes are opposed to each other in the luminous bulb; and a pair of sealing portions for sealing a pair of metal foils electrically connected to the pair of electrodes, respectively; and a reflecting mirror for reflecting light emitted from the discharge lamp and having a front opening for emitting the reflected light. The lamp provided with a mirror is formed so as to have a non-airtight structure. The house includes a transmission window made of a material for transmitting light emitted from the front opening and positioned forward in the emission direction of the front opening of the reflecting mirror.

### BACKGROUND OF THE INVENTION

The present invention relates to lamp units. In particular, the present invention relates to lamp units used as a light source for an image projection apparatus such as a liquid crystal projector or a digital micromirror device (DMD) projector.

In recent years, an image projection apparatus such as a projector using a liquid crystal projector or a DMD has been widely used as a system for realizing large-scale screen images. A high-pressure discharge lamp having a high intensity has been commonly and widely used in such an image projection apparatus. For the light source of the image projection apparatus, light is required to be concentrated on an imaging device included in the optical system of the projector, so that in addition to high intensity, it is also necessary to achieve a light source close to a point light source. Therefore, among high-pressure discharge lamps, a short arc ultra high-pressure mercury lamp that is close to a point light and has a high intensity has been noted widely as a promising light source. The short arc ultra high-pressure mercury lamp can be used as a light source for projectors in the form of a lamp provided with a mirror in combination with a reflecting mirror.

Referring to FIG. 7, a conventional lamp 1200 provided with a mirror including a short arc ultra high-pressure mercury lamp 1000 will be described. FIG. 7 is a schematic top view of a lamp 1200 provided with a mirror including a combination of an ultra high-pressure mercury lamp 1000 and a reflecting mirror 60.

The lamp 1200 provided with a mirror includes a lamp 1000 and a reflecting mirror 60 for reflecting light emitted from the lamp 1000. The lamp 1000 includes a substantially spherical luminous bulb 110 made of quartz glass, and a pair of sealing portions (seal portions) 120 and 120′ made of also quartz glass and connected to the luminous bulb 110. A discharge space 115 is inside the luminous bulb 110. A mercury in an amount of, for example, 150 to 250 mg/cm³ as a luminous material, a rare gas (e.g., argon with several tens kPa) and a small amount of halogen are enclosed in the discharge space 115. A pair of tungsten electrodes (W electrode) 112 and 112′ are opposed with a certain distance (e.g., about 1.5 mm) in the discharge space 115.

The W electrode 112 is welded to a molybdenum foil (Mo foil) 124 in the sealing portion 120, and the W electrode 112 and the Mo foil 124 are electrically connected. The sealing portion 120 includes a glass portion 122 extended from the luminous bulb 110 and the Mo foil 124. The glass portion 122 and the Mo foil 124 are attached tightly so that the airtightness in the discharge space 115 in the luminous bulb 110 is maintained. An external lead (Mo rod) 130 made of molybdenum is joined to one end of the Mo foil 124 by welding, and the Mo foil 124 and the external lead 130 are electrically connected. The configurations of the W electrode 112′ and sealing 120′ are the same as those of the electrode 112 and sealing 120, so that description thereof ill be omitted.

Next, the operational principle of the lamp 1000 will be described. When a start voltage is applied to the W electrodes 112 and 112′ via the external leads 130 and the Mo foils 124, discharge of argon (Ar) occurs. Then, this discharge raises the temperature in the discharge space 115 of the luminous bulb 110, and thus the mercury is heated and evaporated. Thereafter, mercury atoms are excited and become luminous in the arc center between the W electrodes 112 and 112′. As the mercury vapor pressure of the lamp 1000 is higher, the emission efficiency is higher, so that the lamp having a higher mercury vapor pressure is suitable as a light source for an image projection apparatus. However, in view of the physical strength against pressure of the luminous bulb 110, the lamp 1000 is used at a mercury vapor pressure of 15 to 25 MPa.

The light emitted from the discharge lamp 1000 is reflected at the reflecting mirror 60 and emits in the emission direction 50. The reflecting mirror 60 has a front opening 60a on the side of the emission direction 50. As described above, the mercury vapor pressure of the lamp 1000 is set to be within the range that is permitted by the physical strength against pressure of the luminous bulb 110 to prevent the damage of the lamp 1000. However, for the purpose of preventing scattering, if the lamp should be broken, or preventing foreign matter from being directed toward the mirror, a front glass 170 is attached at the front opening 60a. In other words, the lamp 1200 provided with a mirror is of an airtight structure, and scattered matters (glass pieces or mercury) generated, if the lamp should be broken, are prevented from going out. A lead wire 65 for external interconnection is electrically connected to the external lead 130 of the sealing portion 120. The lead wire 65 for external interconnection is extended to the outside of the reflecting mirror 60 through an opening 62 for lead wire and electrically connected to an external circuit (e.g., ballast). The reflecting mirror 60 is attached to the sealing portion 120′ of the discharge lamp 1000, and a lamp base 55 is attached to one end of the sealing portion 120′.

When combining this lamp 1200 provided with a mirror with an optical system of an image projection apparatus (projector), as shown in FIG. 8A, it is general to use a lamp unit 1500 in which the lamp 1200 is integrated with a lamp house 180 for holding the lamp 1200 provided with a mirror.

FIG. 8A is a schematic view of the configuration of an image projection apparatus including the lamp unit 1500 and an optical system 190 (191 to 193), the lamp unit 1500 being partially cut away. FIG. 8B is a perspective view viewed from the front of the lamp house 180 of the lamp unit 1500.

The lamp house 180 is a holding member provided with an opening 180a for emitting light at front, and has a non-airtight structure (having a L-shape in the example of FIGS. 8A and 8B). The lamp house 180 is attached to a predetermined position of the image projection apparatus, so that the lamp unit 1500 can be combined with the optical system 190 of the image projection apparatus. The light emitted from the lamp unit 1500 first reaches an image display device 192 (e.g., DMD or liquid crystal device (LCD)) of the optical system 190 through a lens 191, and then is projected with magnification to a screen (not shown) through a projection lens 193.

Since the conventional lamp 1200 provided with a mirror has an airtight structure, heat generated from the lamp during lamp operation is contained inside the lamp 1200 provided with a mirror, so that the temperature inside the lamp 1200 provided with a mirror is increased. In other words, when the lamp is damaged, the scattered matters of the lamp may come out of the lamp, and therefore, in order to prevent the scattered matters from coming out and ensure the security of the lamp without fail, the lamp 1200 provided with a mirror is required to have an airtight structure. As a result, the temperature in the atmosphere in the inside 61 of the lamp 1200 provided with a mirror is increased during operation, which is accompanied by an increase in the temperature of the sealing portion 120. Molybdenum constituting the Mo foil 124 of the sealing portion 120 has a property that it is oxidized at 350° C. or more. Therefore, the high temperature of the lamp 1200 provided with a mirror causes oxidation of the Mo foil 124 (in particular, a welded portion between the Mo foil 124 and the external lead 130), which causes the conductivity of the Mo foil 124 to be lost, so that the lamp 1200 provided with a mirror stops operating.

In the past, partially because the size of the lamp 1200 provided with a mirror was large, the inside 61 of the lamp 1200 provided with a mirror was comparatively large, so that the temperature increase in the inside 61 of the lamp 1200 provided with a mirror did not cause a large problem in most cases. Furthermore, because of a comparatively short lifetime of the lamp due to deterioration of the luminous portion 110 of the lamp or a comparatively low output of the lamp, the reliability of lamp operation comparatively can be guaranteed, even if the temperature increase occurs in the inside 61 of the lamp 1200 provided with a mirror.

However, nowadays, since the size of the lamp 1200 provided with a mirror is small, the extent of the temperature increase of the inside 61 of the lamp 1200 with a mirror is becoming large. In addition, with improvement of the characteristics of the luminous portion 110 of the lamp, a longer lamp lifetime (e.g., several thousands hours or more) can be provided on the product base. Therefore, in order to guarantee the reliability of lamp operation during a long period, the problem of the temperature increase of the inside 61 of the lamp 1200 provided with a mirror cannot be ignored. Furthermore, under the circumstances that the lamp having a higher output is under development, the temperature of the lamp 1200 provided with a mirror tends to be significantly increased by increasing the output of the lamp. Therefore, it seems that the problem of the temperature increase of the inside 61 of the lamp 1200 provided with a mirror becomes increasingly serious.

The inventors of the present invention found the following phenomenon. When the lamp 1200 provided with a mirror is incorporated into an optical system of a projector using, for example, a DMD, as a light source of the projector, a part of the light emitted from the lamp 1200 provided with a mirror is reflected by the optical system and is incident to the lamp 1200 provided with a mirror, which increases the temperature of the lamp 1200 provided with a mirror. In the case where such a phenomenon occurs, the reliability of lamp operation cannot be guaranteed, even if the lamp 1200 provided with a mirror has been designed with an estimation of the internal temperature of the lamp 1200 provided with a mirror based on the output of the lamp.

Furthermore, the inventors of the present invention examined the approach of making a hole in a part of the reflecting mirror 60 for the purpose of replacing the air in the inside 61 of the lamp 1200 provided with a mirror by the outside air. However, When a hole is made in a part of the reflecting mirror 60, the luminous flux emitted from the lamp 1200 provided with a mirror is reduced because of a reduction in the area that reflects the light emitted from the lamp 1000, and thus the optical performance of the lamp is degraded. Moreover, when a hole is made in a part of the reflecting mirror 60, the lamp 1200 provided with a mirror is not of an airtight structure, which causes a problem in security.

### SUMMARY OF THE INVENTION

Therefore, with the foregoing in mind, it is a main object of the present invention to provide a lamp unit with improved reliability of its operation in which the temperature of the inside of the lamp provided with a mirror is suppressed.

A lamp unit of the present invention includes a lamp provided with a mirror and a house for holding the lamp provided with a mirror. The lamp provided with a mirror includes a discharge lamp including a luminous bulb in which a luminous material is enclosed and a pair of electrodes are opposed to each other in the luminous bulb; and a pair of sealing portions for sealing a pair of metal foils electrically connected to the pair of electrodes, respectively; and a reflecting mirror for reflecting light emitted from the discharge lamp and having a front opening for emitting the reflected light. The lamp provided with a mirror is formed so as to have a non-airtight structure. The house includes a transmission window made of a material for transmitting light emitted from the front opening and positioned forward in the emission direction of the front opening of the reflecting mirror.

It is preferable that the lamp provided with a mirror has a non-airtight structure with the front opening of the reflecting mirror being open.

It is preferable that the house has a structure that can accommodate scattered matters when the discharge lamp is scattered to prevent the scattered matters from coming out.

It is preferable that the house includes an opening for replacing gas inside the house by gas outside the house.

It is preferable that the house has an airtight structure.

It is preferable that the house further includes a convection apparatus for cooling.

The transmission window can be made of glass or reinforced plastics.

It is preferable that the house is made of a metal.

In one embodiment of the present invention, the lamp unit is a lamp unit for image projection apparatus in which the optical axis of the discharge lamp coincides with the optical axis of the reflecting mirror.

In one embodiment of the present invention, the lamp unit is constituted as a replaceable unit as a light source for an image projection apparatus.

According to another aspect of the present invention, an image projection apparatus includes the above-described lamp unit, and an optical system using the lamp unit as a light source. The optical axis of the discharge lamp included in the lamp unit coincides with the optical axis of the lamp unit and the optical axis of the optical system.

In one embodiment of the present invention, the lamp unit is constituted as a replaceable unit as a light source for an image projection apparatus, and the optical system includes at least a lens and an image display device selected from the group consisting of digital micromirror device and a liquid crystal display device.

In the lamp unit of the present invention, the lamp provided with a mirror is formed so as to have a non-airtight structure, and a transmission window is provided in a house (housing) for holding the lamp provided with a mirror. Therefore, it is possible to move the gas inside the lamp provided with a mirror into other portions throughout the house, so that the temperature of the inside of the lamp provided with a mirror during lamp operation can be suppressed over the prior art. As a result, a lamp unit having improved reliability of lamp operation can be provided. Furthermore, since the temperature increase of the lamp provided with a mirror can be suppressed, a lamp unit having a long lamp lifetime can be provided. Furthermore, the transmission window is provided forward in the emission direction of the front opening of the reflecting mirror, so that the transmission window prevents the scattered matters from coming out, even if the scattered matters (e.g., glass pieces or mercury) generated at lamp breakage comes out from the front opening of the reflecting mirror. The lamp provided with a mirror included in the lamp unit of the present invention has a non-airtight structure with the front opening of the reflecting mirror being open, for example.

In the case where the house has a structure that can accommodate the scattered matters, the scattered matters generated at lamp breakage can be prevented from coming out from the lamp unit. Therefore, the security of the lamp unit can be improved further. When an opening for replacing gas in the inside by gas in the outside of the house is provided at least in an upper portion of the house in the vertical direction, the temperature increase of the inside of the lamp provided with a mirror can be suppressed more effectively. When the house has an airtight structure, no scattered matter generated at lamp breakage can come out. When the convection apparatus for cooling is provided in the house, the gas in the house can be convected forcefully, so that the temperature increase of the lamp provided with a mirror can be suppressed more effectively. The transmission window can be made of glass or reinforced plastics. When the house is made of a metal, the heat release properties of the lamp unit can be improved, so that the temperature increase of the lamp provided with a mirror can be suppressed more effectively.

According to the lamp unit of the present invention, the temperature increase of the lamp provided with a mirror during lamp operation can be suppressed. As a result, a lamp unit having improved reliability of lamp operation can be provided. Furthermore, since the temperature increase of the lamp provided with a mirror can be suppressed, a lamp unit having a long lamp lifetime (e.g., of five thousands hours to one million hours) can be provided.

This and other advantages of the present invention will become apparent to those skilled in the art upon reading and understanding the following detailed description with reference to the accompanying figures.

### BRIEF DESCRIPTION OF THE DRAWINGS

FIG. 1 is a schematic view showing the configuration of a lamp unit 500.

FIG. 2 is a view from the back of a reflecting mirror 60 of the lamp unit 500.

FIG. 3 is a schematic cross-sectional view showing the configuration of a lamp unit 600.

FIG. 4 is a schematic cross-sectional view showing the configuration of a lamp unit 700.

FIG. 5 is a schematic cross-sectional view showing the configuration of the lamp unit 800.

FIG. 6 is a schematic cross-sectional view showing the configuration of a lamp unit 900.

FIG. 7 is a schematic view showing the configuration of a conventional lamp 1200 provided with a mirror.

FIG. 8A is a schematic view showing the configuration of an image projection apparatus including a conventional lamp unit 1500 and an optical system 190.

FIG. 8B is a schematic perspective view showing the configuration of a conventional lamp house 180.

### DETAILED DESCRIPTION OF THE INVENTION

Hereinafter, embodiments of the present invention will be described with reference to the accompanying drawings. In the following drawings, for simplification, the elements having substantially the same functions bear the same reference numeral.

Embodiment 1

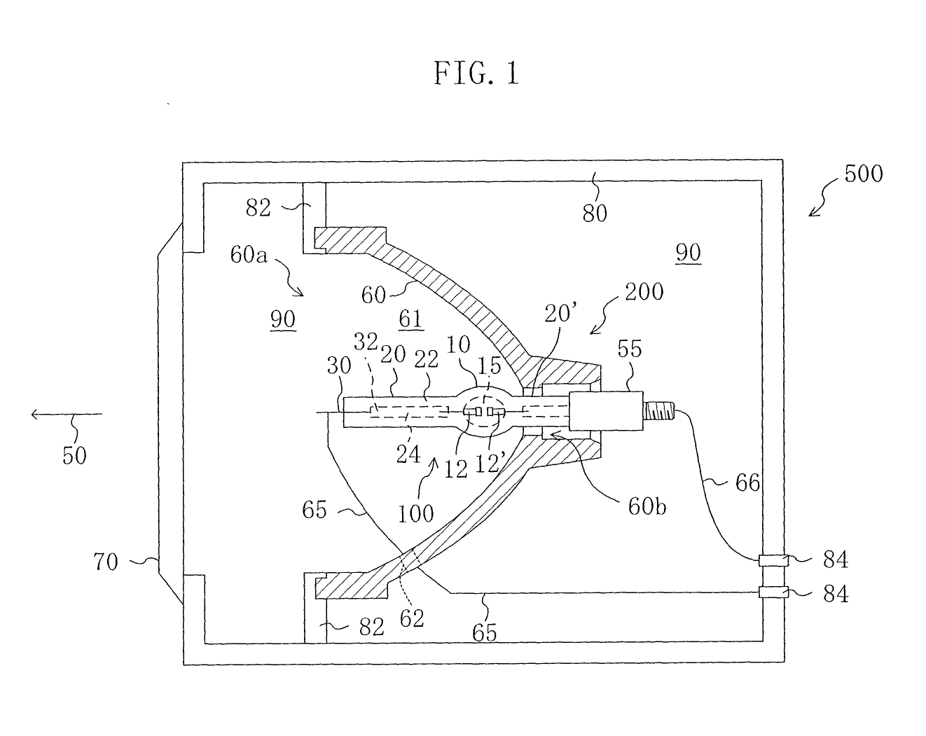

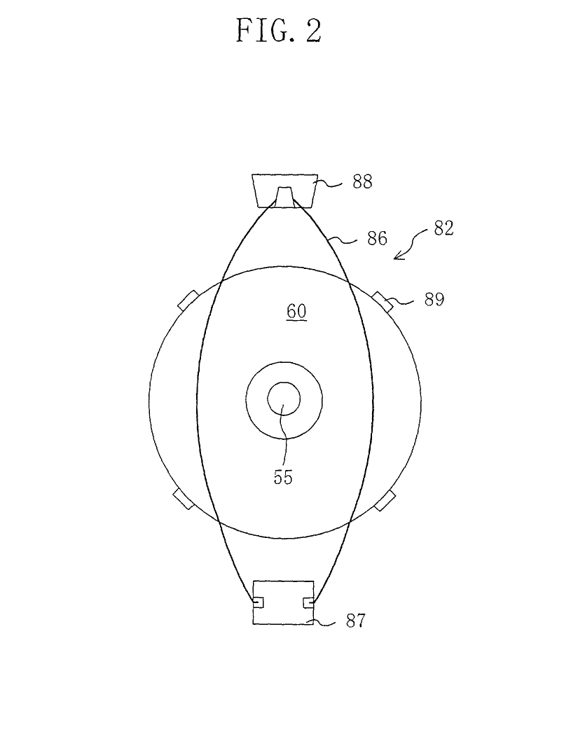

Embodiment 1 of the present invention will be described with reference to FIGS. 1 and 2. FIG. 1 is a schematic view showing the configuration of a lamp unit 500 of Embodiment 1.

The lamp unit 500 includes a lamp 200 provided with a mirror and a house (lamp house) 80 for holding the lamp 200 provided with a mirror. The lamp 200 provided with a mirror includes a discharge lamp 100 and a reflecting mirror 60 for reflecting light emitted from the discharge lamp 100. The lamp 200 provided with a mirror has a non-airtight structure in which a front glass is not provided at a front opening 60a of the reflecting mirror 60. In other words, the lamp 200 provided with a mirror has a non-airtight structure in which the front opening 60a of the reflecting mirror 60 is open. Furthermore, the house 80 for holding the lamp 200 provided with a mirror has a transmission window 70 made of a material that transmits light emitted from the front opening 60a in a portion forward in the emission direction 50 of the from opening 60a of the reflecting mirror 60. The house 80 serves to protect the lamp 200 provided with a mirror, in addition to serving to hold the lamp 200 provided with a mirror.

The discharge lamp 100 included in the lamp unit 500 includes a luminous bulb 10, and a pair of sealing portions 20 and 20′ connected to the luminous bulb 10. A discharge space 15 in which a luminous material 18 is enclosed is provided inside the luminous bulb 10. A pair of electrodes 12 and 12′ are opposed to each other in the discharge space 15. The luminous bulb 10 is made of quartz glass and is substantially spherical. The outer diameter of the luminous bulb 10 is, for example, about 5 mm to 20 mm. The glass thickness of the luminous bulb 10 is, for example, about 1 mm to 5 mm. The volume of the discharge space 15 in the luminous bulb 10 is, for example, about 0.01 to 1 cc. In this embodiment, the luminous bulb 10 having an outer diameter of about 13 mm, a glass thickness of about 3 mm, a volume of the discharge space 15 of about 0.3 cc is used. As the luminous material, mercury is used. For example, about 150 to 200 mg/cm³ of mercury, a rare gas (e.g., argon) with 5 to 20 kPa, and a small amount of halogen are enclosed in the discharge space 15.

The pair of electrodes 12 and 12′ in the discharge space 15 is arranged with a gap (arc length) of, for example, about 1 to 5 mm (preferably about 1 to 3 mm). As the electrodes 12 and 12′, for example, tungsten electrodes (W electrodes) are used. In this embodiment, the W electrodes 12 and 12′ are arranged with a gap of about 1.5 mm. The electrode axis (W rod) of the electrode 12 is electrically connected to the metal foil 24 in the sealing portion 20. Similarly, the electrode axis of the electrode 12′ is electrically connected to the metal foil 24′ in the sealing portion 20′.

The sealing portion 20 includes a metal foil 24 electrically connected to the electrode 12 and a glass portion 22 extended from the luminous bulb 10. The airtightness in the discharge space 15 in the luminous bulb 10 is maintained by the foil-sealing between the metal foil 24 and the glass portion 22. The glass portion 22 of the sealing portion 20 is made of quartz glass, for example. The metal foil 24 is a molybdenum foil (Mo foil), for example, and has a rectangular shape, for example. The sealing portion 20 has a circular shape in section, for example. The metal foil 24 is positioned substantially in the center of the sealing portion 20. The metal foil 24 of the sealing portion 20 is joined to the electrode 12 by welding, and the metal foil 24 has an external lead 30 on the side opposite to the side that is joined to the electrode 12. The external lead 30 is formed of, for example, molybdenum, and connected to the metal foil 24 at a connection portion 32 by welding. The configuration of the sealing portion 20′ is the same as that of the sealing portion 20, so that the description thereof is omitted. One sealing portion 20 is arranged on the side of the front opening 60a of the reflecting mirror 60 (on the side of the emission direction 50), and the other sealing portion 20′ is fixed to the reflecting mirror 60. A lamp base 55 is attached to an end of the sealing portion 20′. The sealing portion 20′ and the reflecting mirror 60 are attached with, for example, an inorganic adhesive (e.g., cement) to form one unit.

The reflecting mirror 60 fixed to the sealing portion 20′ is designed to reflect the light radiated from the discharge lamp 100 such that the light becomes a parallel luminous flux, a condensed luminous flux converged on a predetermined small area, or a divergent luminous flux equal to that emitted from a predetermined small area. As the reflecting mirror 60, a parabolic reflector or an ellipsoidal mirror can be used, for example. An opening 62 for a lead wire is provided in the reflecting mirror 60, and the lead wire 65 for external interconnection is drawn out of the reflecting mirror 60 through the opening 62 for a lead wire. The lead wire 65 for external interconnection that is drawn out of the reflecting mirror 60 is electrically connected to a terminal 84 provided in the house 80, and the terminal 84 is electrically connected to an external circuit (e.g., ballast). The lamp base 55 of the lamp 100 also is electrically connected to the terminal 84 through a lead wire 66 for external interconnection.

The reflecting mirror 60 is fixed to the house 80 with a mirror holding member 82. There is no limitation regarding the mirror holding member 82, as long as it can hold the reflecting mirror 60. For example, the reflecting mirror 60 can be fixed to the house 80 with a connecting member (screw, bolt, nut, etc.). Alternatively, the reflecting mirror 60 can be fitted into the mirror holding member 82. Furthermore, the reflecting mirror 60 and the mirror holding member 82 can be attached or adhered to each other, or the reflecting mirror 60 can be fixed to the house 80 with magnetic force.

In this embodiment, for the purpose of simplifying the configuration of the mirror holding member 82, the reflecting mirror 60 is pressed to a part of the house 80, utilizing the force of a band 86, to constitute the mirror holding member 82, as shown in FIG. 2. FIG. 2 is a schematic view of the reflecting mirror 60 viewed from its back.

As shown in FIG. 2, the band (e.g., wire) 86 is fixed at both ends with a band fixture 87, and has a circular (ring-shaped) structure. A part of the band 86 can be hooked to a band fastener (buckle) 88. With this configuration, the band 86 is set along the back surface of the reflecting mirror 60, and the band 86 is hooked to the band fastener 88, so that the reflecting mirror 60 easily can be fixed to the house 80. The mirror holding member 82 shown in FIG. 2 easily can fix the lamp 200 provided with a mirror with a simple configuration, so that the mirror holding member 82 has a large advantage in assembling a lamp unit. It is preferable to provide a hook 89 for movement prevention for preventing the reflecting mirror 60 from moving after the reflecting mirror 60 is fixed.

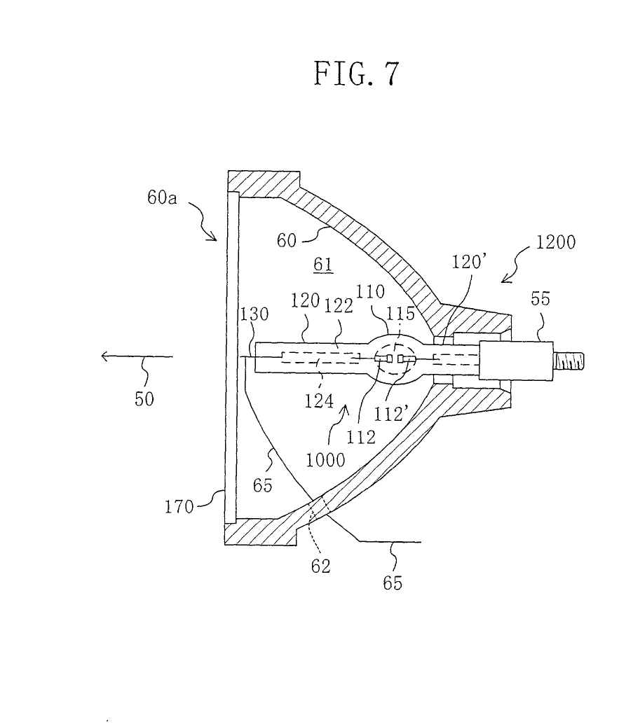

Referring back to FIG. 1, the transmission window 70 included in the house 80 is constituted by, for example, glass or reinforced plastics. The transmission window 70 is provided forward in the emission direction 50 of the front opening 60a of the reflecting mirror 60, and therefore even if the scattered matters(e.g., glass pieces or mercury) generated at lamp breakage comes out from the front opening 60a of the reflecting mirror 60, the transmission window 70 prevents the scattered matters from coming out. Therefore, in the lamp unit 500 of this embodiment, even if the lamp 200 provided with a mirror that is not provided with the front glass at the front opening 60a of the reflecting mirror 60 is used, the transmission window 70 ensures the security of the lamp. In the lamp unit 500 of this embodiment, the temperature of the house 80 during lamp operation can be lower than that of the mirror 60 of the conventional lamp 1200 provided with a mirror shown in FIG. 7, so that another advantage is that not only glass, but also reinforced plastics can be used preferably as the material for the transmission window 70. In this embodiment, an opening is formed at the front of the house 80 positioned forward in the emission direction 50, and the transmission window 70 is provided so as to cover the opening from the outside of the house 80, but the present invention is not limited thereto, and the transmission window 70 is provided so as to cover the opening from the inside of the house 80. Furthermore, the transmission window 70 may be provided in a part (e.g., central portion) or the entire portion of the front of the house 80 positioned forward in the emission direction 50. In this embodiment, the house 80 is designed to have an airtight structure, so that even if the lamp 100 is broken and scattered matters (glass pieces or mercury) are generated, the scattered matters are prevented from coming out from the lamp unit 500. In other words, the configuration of the house 80 can accommodate the scattered matters so as to prevent the scattered matters from coming out, so that the security of the lamp can be ensured further.

The house 80 is formed of, for example, a metal (e.g., aluminum, stainless steel, iron, etc.). Metals typically have high heat conductivity, so that metals can improve the heat release properties of the house 80 (lamp 200 provided with a mirror). Furthermore, in the case of the house 80 formed of metal, the house 80 can be reused easily so that this is advantageous in view of recycle of the resources. The volume of the inside 90 of the house 80 in this embodiment is, for example, about 800 to 2000 cm³. On the other hand, the volume of the inside 61 of the reflecting mirror 60 is, for example, about 200 cm³. Thus, the volume of the inside 90 of the house 80 can be four to 10 times as large as the volume of the inside 61 of the reflecting mirror 60. According to the configuration of the lamp unit 100 of this embodiment, it is possible to reduce the temperature by about 10 to 50° C. lower than that of the inside 61 of the conventional lamp 1200 provided with a mirror during lamp operation. In FIG. 1, the inside 90 of the house 80 forward of the reflecting mirror 60 is in communication with the inside 90 of the house 80 backward of the reflecting mirror 60, and the air in the inside 90 of the house 80 can move freely throughout the house 80.

In this embodiment, the lamp 100 and the reflecting mirror 60 in the lamp unit 500 are designed so that their optical axes coincide with each other, so that the lamp unit 500 can be used preferably as the light source of an image projection apparatus. It is known that when the optical axis alignment is not satisfactory, image forming by the image projection apparatus is poor. For example, a dislocation of only 0.4 mm in the optical axes reduces the brightness on the screen by up to about 60%. When the lamp unit 500 is used as a headlight of an automobile, strict alignment of the optical axes is not necessarily required because it only needs to illuminate forward.

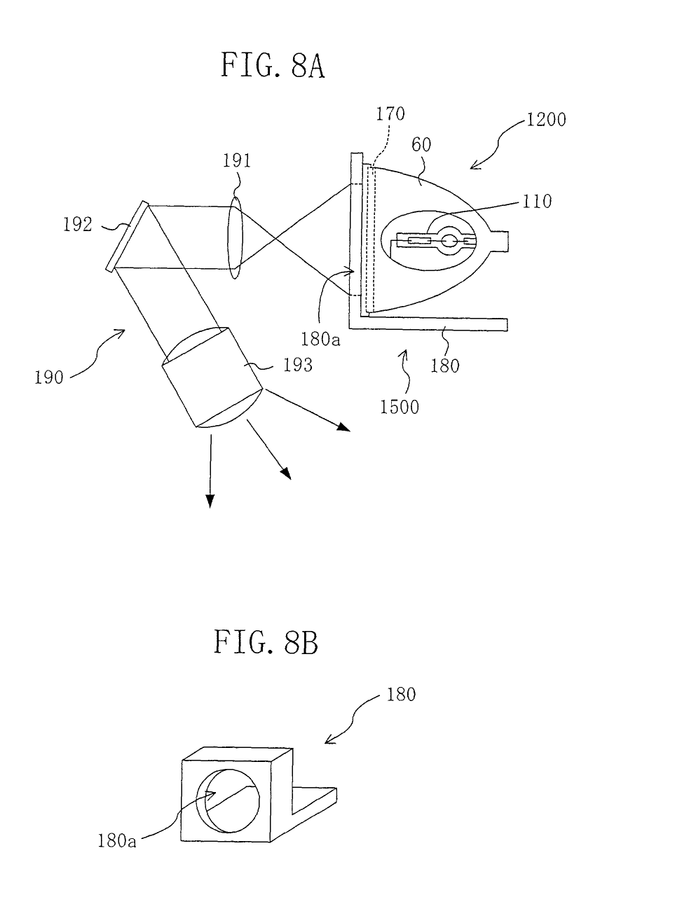

Furthermore, when combining the lamp unit 500 with the optical system 190 (191 to 193) shown in FIG. 8 to constitute an image projection apparatus, the lamp unit 500 is designed so as to form a replaceable unit as the light source for an image projection apparatus, so that the lamp unit 500 very easily can be attached to the image projection apparatus or replaced. Furthermore, when setting the lamp unit 500 in a position for a lamp unit installation in the image projection apparatus, in the case where the optical axis of the lamp unit 500 is designed to coincide with the optical axis of the optical system 190, simply attaching or replacing the lamp unit 500 can complete the alignment of the optical axes.

According to the present invention, the lamp unit 500 is provided with the lamp 200 provided with a mirror having a non-airtight structure in which a front glass is not provided at the front opening 60a of the reflecting mirror 60, and therefore the air in the inside 61 of the lamp 200 provided with a mirror whose temperature is increased during lamp operation can convect (move), not only in the inside 61 of the lamp 200 provided with a mirror, but also in a wide range throughout the inside 90 of the house 80. Therefore, the temperature increase in the lamp 200 provided with a mirror during lamp operation can be suppressed more than in the case of the conventional lamp 1200 provided with a mirror in which convention is caused only in the inside 61 of the reflecting mirror 60. As a result, the reliability of the lamp operation can be improved further. Furthermore, since the lamp can be used in the state where the temperature increase in the lamp 200 provided with a mirror is suppressed, the lifetime of the lamp can be prolonged. Furthermore, the house 80 having the transmission window 70 can ensure the security of the lamp. In addition, the lamp unit 500 is a replaceable unit as a light source for an image projection apparatus, so that the lamp unit 500 can be attached to the image projection apparatus or replaced very easily. In the case where the lamp unit 500 is designed with the optical axis alignment taken into consideration when setting the lamp unit 500, the optical axis alignment can be completed by attaching or replacing the lamp unit 500.

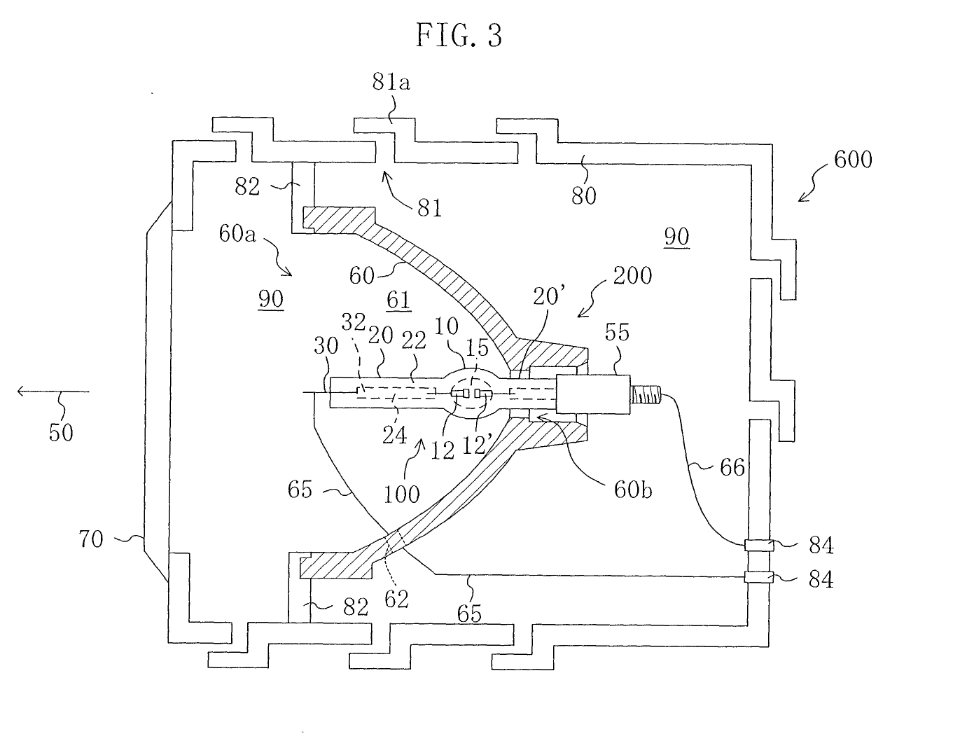

In the lamp unit 500 of this embodiment, the house 80 having an airtight structure is used. However, it is possible to use the house 80 provided with the opening 81, if the house 80 has a structure in which the scattered matters from the lamp 100 when the lamp is scattered are accommodated so as not to come out, as shown in FIG. 3. In the lamp unit 600 shown in FIG. 3, a lid portion 81a covering the upper portion of the opening 81 so as to prevent the scattered matters from coming out from the opening 81 is formed in the house 80.

The lid portion 81a is spaced away from the outer wall of the house 80, so that the air in the inside 90 of the house 80 is in communication with the outside air through the opening 81 and the gap between the lid portion 81a and the house 80. Therefore, even if the temperature of the air of the inside 90 of the house 80 is increased as a result of the temperature increase of the air in the inside 61 of the lamp 200 provided with a mirror during lamp operation, the air can be replaced by the outside air through the opening 81. For this reason, the temperature increase of the lamp 200 provided with a mirror can be suppressed further. The air having a high temperature moves upward in the vertical direction by convection. Therefore, in order to replace the air in the inside 90 of the house 80 by the outside air efficiently, it is preferable to provide the opening 81 at least in an upper portion in the vertical direction of the house 80.

It is sufficient to provide at least one opening 81, but it is preferable to form a plurality of openings 81 in order to increase the efficiency of the replacement of the air in the inside of the house 80 by the outside air. In the case where the opening 81 is formed in a lower surface and/or a side, in addition to the upper surface of the house 80, the configuration can be that the openings 81 are provided in a portion having the lowest temperature and in a portion having the highest temperature, so that convection can be caused efficiently. As a result, it is possible to replace the air in the inside 90 more effectively.

In the lamp unit 600, the lid portion 81a is provided in the opening 81 of the house 80 to form a configuration that accommodates scattered matters to prevent the scattered matters from coming out. However, there is no particular limitation regarding the configuration of the house 80. For example, a net that prevents the scattered matters from coming out may be provided.

Embodiment 2

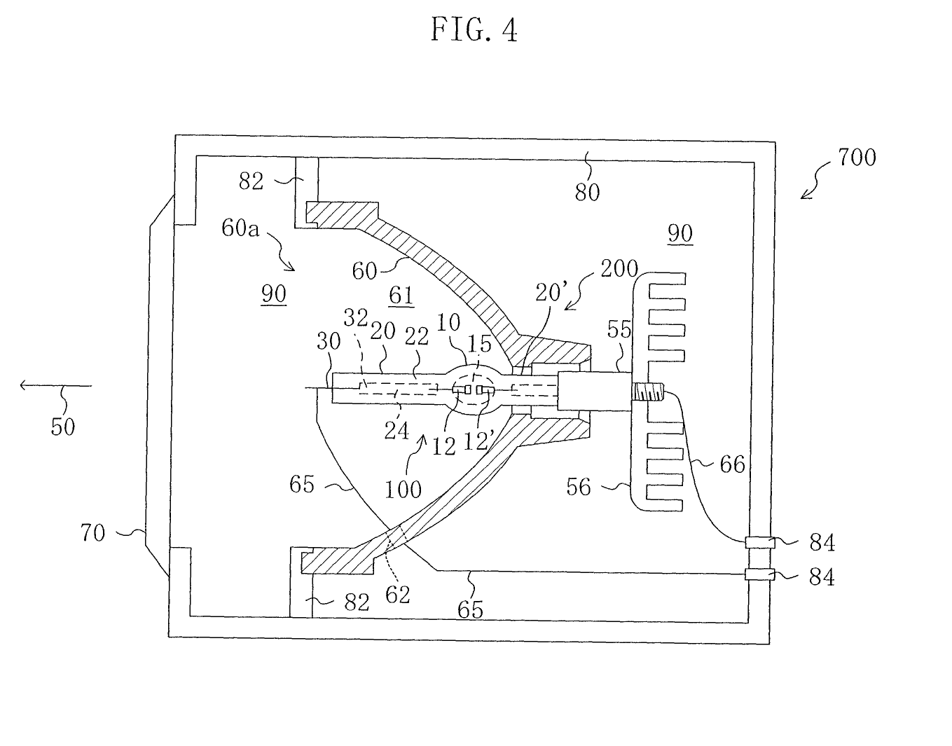

The lamp unit 500 of Embodiment 1 can be modified to form a lamp unit 700 in which a heat sink 56 is provided in the lamp base 55 of the lamp 100 for the purpose of further reducing the temperature increase of the lamp 200 provided with a mirror. FIG. 4 is a schematic view of the configuration of the lamp unit 700 of this embodiment.

The heat sink 56 attached to the lamp 100 of the lamp unit 700 is thermally coupled to the lamp 100 and has a function to suppress the temperature increase of the lamp by enlarging the surface area. The heat sink 56 is, for example, a fin for radiation, and is made of a material having a high heat conductivity (e.g., metal materials such as Al and Cu). The temperature increase of the lamp 200 provided with a mirror during lamp operation can be suppressed more effectively by providing the heat sink 56. It is possible to provide the opening 81 for replacing the air in the inside 90 of the house 80 by the outside air, as in the lamp unit 600 shown in FIG. 3, also in the case where the heat sink 56 is provided.

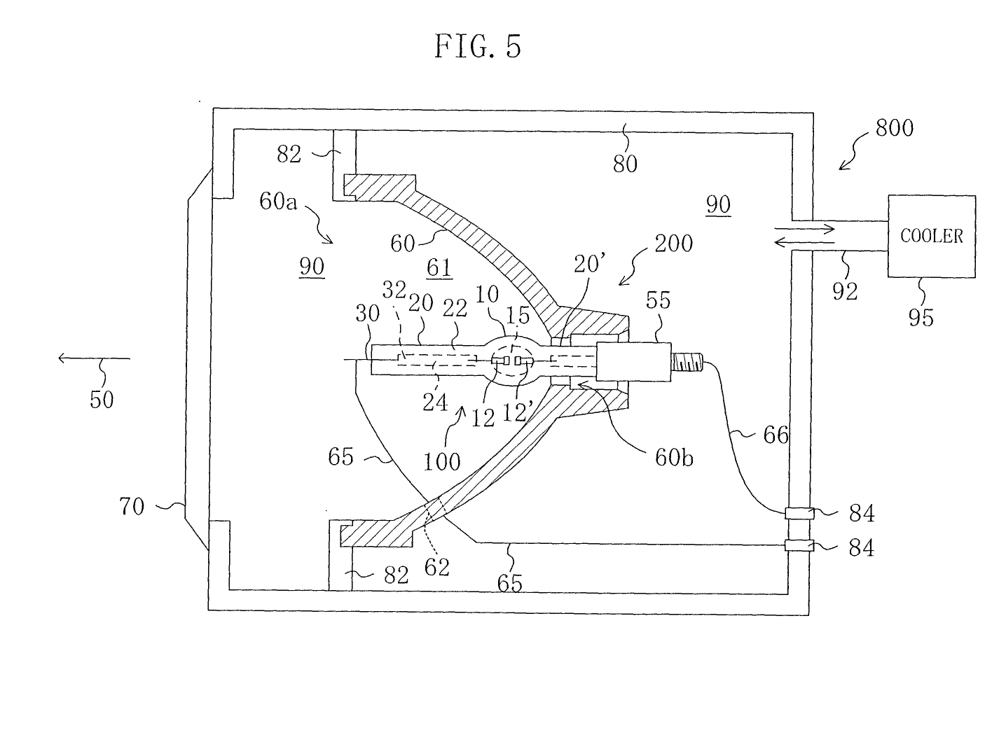

Furthermore, when further effective suppression of the temperature increase of the lamp 200 provided with a mirror is desired, as shown in the lamp unit 800 of FIG. 5, a convection apparatus 95 for cooling can be provided in the house 80 of the lamp unit 500 of Embodiment 1. The convection apparatus 95 for cooling is, for example, a cooling fan for forcefully causing the air in the inside 90 of the house 80 to convect. The convection apparatus 95 for cooling is coupled to the house 80 via, for example, a pipe 92, and the air in the inside 90 of the house 80 is forcefully convected and cooled by the convection apparatus 95 for cooling. As a result, the temperature increase of the lamp 200 provided with a mirror can be suppressed more effectively. In the lamp unit 800, it is possible to reduce the temperature by about 50° C. to about 100° C. from that of the inside 61 of the conventional lamp 1200 provided with a mirror during lamp operation. Although one pipe 92 is provided in FIG. 5, separate pipes for drawing-in and drawing-out can be used. The convection apparatus 95 for cooling has a function to cool by forcefully convecting the air of the inside 90 of the house 80, so that the convection apparatus 95 for cooling can be attached to the house 80 of either the lamp unit 600 or 700.

The configuration in which the temperature of the gas is directly cooled by providing a cooler in the convection apparatus 95 for cooling, as well as cooling by the cooling fan is preferable to suppress the temperature increase of the lamp 200 provided with a mirror. Furthermore, it is possible to use, for example, an inert gas (N₂, etc.) instead of the air in the inside 90 of the house 80. Furthermore, it is possible to provide a pipe 92 connected to the convection apparatus 95 for cooling on the back of the reflecting mirror 60 of the lamp 200 provided with a mirror and to allow a coolant (e.g., water) to flow through the pipe 92 for the purpose of directly reducing the temperature increase of the lamp 200 provided with a mirror. In other words, it is possible to forcefully reduce the temperature of the lamp 200 provided with a mirror by the approach of allowing a coolant to flow. It seems that such an approach of forcefully suppressing the temperature increase of the lamp provided with a mirror is more effective when used for the lamp provided with a mirror that has been developed for higher wattage.

Other embodiments

The lamp units of the above embodiments can reduce the temperature in the inside of the lamp provided with a mirror from that of the conventional configuration, so that it is possible to reduce the length of the metal foil 24 in the sealing portion 20 that also serves to release the heat in the lamp 100. This can reduce the size of the lamp 100, and therefore it is possible to provide a lamp unit including a smaller lamp 200 provided with a mirror. Furthermore, the temperature in the inside of the lamp provided with a mirror during lamp operation can be reduced from that in the conventional lamp, which may make it possible to constitute the metal foil made of a material other than molybdenum.

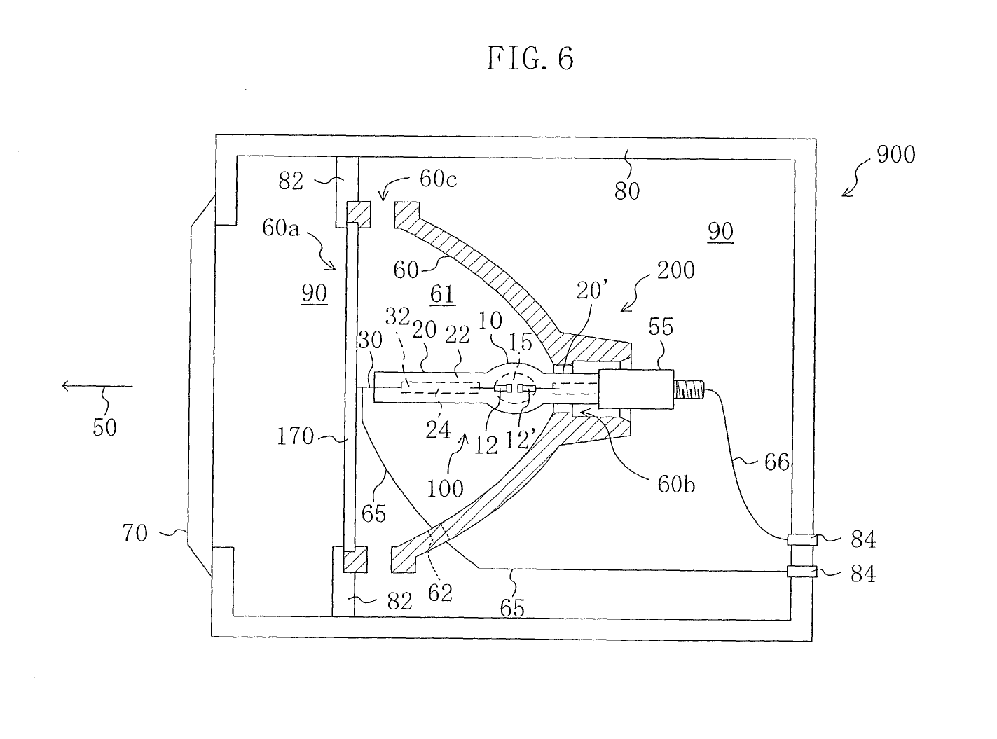

Furthermore, the above embodiments have been described by taking the non-airtight lamp 200 provided with a mirror without the front glass in the front opening 60a of the reflecting mirror 60 as an example. However, a non-airtight lamp 200′ provided with a mirror as shown in FIG. 6 can be used, where a front glass 170 is provided in the front opening 60a, and an opening (through hole) 60c for drawing the air in and out is provided in a part of the reflecting mirror 60. In the case of the configuration FIG. 6, the opening 60c is provided in a position that is most distant from the luminous bulb 10 of the lamp 100 and where the efficiency of the light reflection is not reduced very much. For example, a plurality of openings are formed in a position near the front opening 60a of the reflecting mirror 60. In the case of the lamp unit 900 having the configuration shown in FIG. 6, there are substantially two front glasses, that is, the transmission window 70 of the house 80 and the front glass 170 of the lamp 200 provided with a mirror, so that the effect of preventing scattering forward can be large.

In the above embodiments, mercury lamps employing mercury as the luminous material have been described as an example of the discharge lamp. However, the present invention can apply to any discharge lamps in which the airtightness of the luminous bulb is maintained by the sealing portion (seal portion). For example, the present invention can apply to a discharge lamp enclosing a metal halide such as a metal halide lamp.

Furthermore, in the above embodiments, the case where the mercury vapor pressure is about 20 MPa (the case of so-called ultra high-pressure mercury lamp) has been described. However, the present invention can apply to a high-pressure mercury lamp where the mercury vapor pressure is about 1 MPa or a low pressure mercury lamp where the mercury vapor pressure is about 1 kPa. Furthermore, the lamp can be of a short arc type where the distance (arc length) between the pair of electrodes 12 and 12′ is short, or the distance can be longer than that. The discharge lamps of the above embodiments can be used by either alternating current lighting or direct current lighting.

The lamp units in the above embodiments can be used preferably as the light source of a projector. In addition, the lamp units also can be used as the light source for ultraviolet ray steppers, the light source for sports stadiums, the light source for headlights for automobiles or floodlights illuminating road signs.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A lamp unit comprising:
a lamp provided with a mirror and a house for holding the lamp provided with a mirror,
wherein the lamp provided with a mirror comprises:
a discharge lamp including a luminous bulb in which a luminous material is enclosed and a pair of electrodes are opposed to each other in the luminous bulb; and a pair of sealing portions for sealing a pair of metal foils electrically connected to the pair of electrodes, respectively; and
a reflecting mirror for reflecting light emitted from the discharge lamp and having a front opening for emitting the reflected light,
the lamp provided with a mirror is formed so as to have a non-airtight structure, and
the house includes a transmission window made of a material for transmitting light emitted from the front opening and positioned forward in the emission direction of the front opening of the reflecting mirror.

2. The lamp unit according to claim 1, wherein the lamp provided with a mirror has a non-airtight structure with the front opening of the reflecting mirror being open.

3. The lamp unit according to claim 1, wherein the house has a structure that can accommodate scattered matters when the discharge lamp is scattered to prevent the scattered matters from coming out.

4. The lamp unit according to claim 1, wherein the house includes an opening for replacing gas inside the house by gas outside the house.

5. The lamp unit according to claim 3, wherein the house has an airtight structure.

6. The lamp unit according to claim 5, wherein the house further includes a convection apparatus for cooling.

7. The lamp unit according to claim 1, wherein the transmission window is made of glass or reinforced plastics.

8. The lamp unit according to claim 1, wherein the house is made of a metal.

9. The lamp unit according to claim 1, wherein the lamp unit is a lamp unit for image projection apparatus in which an optical axis of the discharge lamp coincides with an optical axis of the reflecting mirror.

10. The lamp unit according to claim 9, wherein the lamp unit is constituted as a replaceable unit as a light source for an image projection apparatus.

11. An image projection apparatus comprising the lamp unit of claim 1, and an optical system using the lamp unit as a light source,
wherein an optical axis of the discharge lamp included in the lamp unit coincides with an optical axis of the lamp unit and an optical axis of the optical system.

12. The image projection apparatus according to claim 11,
wherein the lamp unit is constituted as a replaceable unit as a light source for an image projection apparatus, and
the optical system includes at least a lens and an image display device selected from the group consisting of digital micromirror device and a liquid crystal display device.
